(19) United States
(12) Patent Application Publication
(10) Pub. No.: US 2025/0126567 A1
(43) Pub. Date: Apr. 17, 2025

(54) METHOD AND APPARATUS FOR CONTROLLING RADIO UNITS IN WIRELESS COMMUNICATION SYSTEM

(71) Applicant: Electronics and Telecommunications Research Institute, Daejeon (KR)

(72) Inventors: Seung Eun HONG, Daejeon (KR); Jung Mo MOON, Daejeon (KR)

(21) Appl. No.: 18/915,191

(22) Filed: Oct. 14, 2024

(30) Foreign Application Priority Data
Oct. 13, 2023 (KR) 10-2023-0137113
Oct. 11, 2024 (KR) 10-2024-0138330

(51) Int. Cl. H04W 52/02; H04L 47/80; H04W 36/16

(52) U.S. Cl. CPC H04W 52/0274; H04L 47/805; H04W 36/165

(57) ABSTRACT

A method of an NES controller comprises: receiving a first NES intent instructing additional energy saving; determining a first cell to be deactivated based on the first NES intent; obtaining a first UE list of all UEs served by the first cell; determining whether all UEs included in the first UE list are capable of handover; in response to determining that all UEs included in the first UE list are capable of handover, transmitting a handover instruction command to a first base station managing the first cell, so that all UEs included in the first UE list are handed over to individual target cells; and in response to receipt of a handover complete message for all UEs included in the first UE list from the first base station, transmitting deactivation instruction information of the first cell to the first base station.

### CROSS-REFERENCE TO RELATED APPLICATIONS

This application claims priority to Korean Patent Applications No. 10-2023-0137113, filed on Oct. 13, 2023, and No. 10-2024-0138330, filed on Oct. 11, 2024, with the Korean Intellectual Property Office (KIPO), the entire contents of which are hereby incorporated by reference.

### BACKGROUND

### 1. Technical Field

The present disclosure relates to a technique for controlling radio units (Rus) in a wireless communication system, and more particularly, to a technique for controlling Rus in an open-radio access network (O-RAN) system.

### 2. Related Art

With the commercialization of 5G, innovations and economic achievements utilizing 5G technology are being realized across various industries, and research on 6G technology has already begun to accelerate continuous technological evolution and innovation. Meanwhile, in response to climate change and aiming for sustainable development, network energy saving technologies, beyond low-power operation technologies for devices, are gaining attention. In mobile communication systems, power consumption improvement technologies have primarily evolved from the perspective of devices, but to achieve goals such as reducing operating expenses (OPEX) for telecom operators and achieving carbon neutrality, the application of low-power operation technologies to networks is also essential.

Recently, beyond standardized radio and baseband equipment, ‘open radio access network (O-RAN)’, which accelerates the establishment of an open ecosystem and technological innovation in cellular mobile communications by disaggregating a radio access network (RAN) into smaller components and standardizing interfaces therebetween, has been gaining attention. There have already been reports of several telecom operators deploying O-RAN devices in commercial 5G networks. The disaggregation and virtualization characteristics of O-RAN provide a structure highly advantageous for energy savings through the establishment of energy efficiency goals for each component and the development of technologies to achieve them. In particular, on an O-RAN's RAN intelligent controller (RIC) framework, artificial intelligence (AI)/machine learning (ML) can be utilized to optimize resource and power usage.

However, when energy efficiency is the sole focus in an O-RAN system, it can lead to a deterioration in service quality. Therefore, technologies are needed to enhance energy efficiency while preventing such degradation in service quality.

### SUMMARY

The present disclosure for resolving the above-described problems is directed to providing a method and an apparatus for increasing energy efficiency while preventing degradation of service quality in an O-RAN system.

According to a first exemplary embodiment of the present disclosure, a method of a network energy saving (NES) controller may comprise: receiving a first network energy saving (NES) intent instructing additional energy saving; determining a first cell to be deactivated based on the first NES intent; obtaining a first user equipment (UE) list of all UEs served by the first cell; determining whether all UEs included in the first UE list are capable of handover; in response to determining that all UEs included in the first UE list are capable of handover, transmitting a handover instruction command to a first base station managing the first cell, so that all UEs included in the first UE list are handed over to individual target cells; and in response to receipt of a handover complete message for all UEs included in the first UE list from the first base station, transmitting deactivation instruction information of the first cell to the first base station.

The method may further comprise: receiving a first quality of service (QoS) degradation (QSD) intent; determining whether a QoS of all UEs included in the first UE list when handed over is within an allowable range of the first QSD intent; and in response to determining that the QoS of all UEs included in the first UE list when handed over is within the allowable range of the first QSD intent, determining the first cell as a deactivation target.

The method may further comprise: in response to determining that the QoS of all UEs included in the first UE list when handed over is not within the allowable range of the first QSD intent, excluding the first cell from a deactivation target; determining a second cell to be deactivated that satisfies the allowable range of the first QSD intent; obtaining a second UE list including all UEs served by the second cell; determining whether all UEs included in the second UE list are capable of handover; in response to determining that all UEs included in the second UE list are capable of handover, transmitting a handover instruction command to a second base station managing the second cell, so that all UEs included in the second UE list are handed over to individual target cells; and in response to receipt of a handover complete message for all UEs included in the second UE list from the second base station, transmitting deactivation instruction information of the second cell to the second base station.

The method may further comprise: in response to a second cell to be further deactivated based on the first NES intent, determining whether all UEs served by the second cell are capable of handover; in response to determining that all UEs served by the second cell are capable of handover, transmitting a handover instruction command to a second base station managing the second cell, so that all UEs served by the second cell are handed over to individual target cells; and in response to receipt of a handover complete message for all UEs in the second cell from the second base station, transmitting deactivation instruction information of the second cell to the second base station.

The method may further comprise: when transmitting the deactivation instruction information of the first cell, transmitting instruction information instructing an increase in signal transmission power of adjacent cell(s) of the first cell to one or more base stations managing the adjacent cell(s), so that the adjacent cell(s) cover a range of the first cell.

The determining of the first cell to be deactivated based on the first NES intent may comprise: calculating a number of candidate cells to be deactivated based on the first NES intent; providing information on the number of candidate cells to a cell abnormality detector; and receiving a list of candidate cells to be deactivated from the cell abnormality detector.

The method may further comprise: receiving a second NES intent instructing an increase in network energy; generating a list of candidate cells to be activated in an order from a cell having a highest load to a cell having a lowest load among cells adjacent to deactivated cells based on the second NES intent; and transmitting a reactivation command to a second base station managing a fourth cell, so that the fourth cell adjacent to a third cell having the highest load among cells included in the list of candidate cells is reactivated.

The method may further comprise: determining UEs to be handed over to the fourth cell among UEs served by the third cell; and transmitting handover instruction information to the second base station, so that handover commands are transmitted to the UEs to be handed over to the fourth cell.

The method may further comprise: receiving a first quality of service (QoS) degradation (QSD) intent; in response to receipt of overloaded cell information for a second cell from a cell abnormality detector, generating a candidate UE list of UEs capable of handover from the second cell to adjacent third cells; determining a target cell for handover based on the first QSD for each of the UEs included in the candidate UE list, a target cell for a specific UE being one of the third cells; and transmitting a handover instruction command to second base station(s) managing the third cells, so that a handover command for handover to the determined target cell is transmitted to each of the UEs included in the candidate UE list.

According to a second exemplary embodiment of the present disclosure, a network energy saving (NES) controller may comprise at least one processor, and the at least one processor may cause the NES controller to perform: receiving a first network energy saving (NES) intent instructing additional energy saving; determining a first cell to be deactivated based on the first NES intent; obtaining a first user equipment (UE) list of all UEs served by the first cell; determining whether all UEs included in the first UE list are capable of handover; in response to determining that all UEs included in the first UE list are capable of handover, transmitting a handover instruction command to a first base station managing the first cell, so that all UEs included in the first UE list are handed over to individual target cells; and in response to receipt of a handover complete message for all UEs included in the first UE list from the first base station, transmitting deactivation instruction information of the first cell to the first base station.

The at least one processor may further cause the NES controller to perform: receiving a first quality of service (QoS) degradation (QSD) intent; determining whether a QoS of all UEs included in the first UE list when handed over is within an allowable range of the first QSD intent; and in response to determining that the QoS of all UEs included in the first UE list when handed over is within the allowable range of the first QSD intent, determining the first cell as a deactivation target.

The at least one processor may further cause the NES controller to perform: in response to determining that the QoS of all UEs included in the first UE list when handed over is not within the allowable range of the first QSD intent, excluding the first cell from a deactivation target; determining a second cell to be deactivated that satisfies the allowable range of the first QSD intent; obtaining a second UE list including all UEs served by the second cell; determining whether all UEs included in the second UE list are capable of handover; in response to determining that all UEs included in the second UE list are capable of handover, transmitting a handover instruction command to a second base station managing the second cell, so that all UEs included in the second UE list are handed over to individual target cells; and in response to receipt of a handover complete message for all UEs included in the second UE list from the second base station, transmitting deactivation instruction information of the second cell to the second base station.

The at least one processor may further cause the NES controller to perform: in response to a second cell to be further deactivated based on the first NES intent, determining whether all UEs served by the second cell are capable of handover; in response to determining that all UEs served by the second cell are capable of handover, transmitting a handover instruction command to a second base station managing the second cell, so that all UEs served by the second cell are handed over to individual target cells; and in response to receipt of a handover complete message for all UEs in the second cell from the second base station, transmitting deactivation instruction information of the second cell to the second base station.

The at least one processor may further cause the NES controller to perform: when transmitting the deactivation instruction information of the first cell, transmitting instruction information instructing an increase in signal transmission power of adjacent cell(s) of the first cell to one or more base stations managing the adjacent cell(s), so that the adjacent cell(s) cover a range of the first cell.

In the determining of the first cell to be deactivated based on the first NES intent, the at least one processor may further cause the NES controller to perform: calculating a number of candidate cells to be deactivated based on the first NES intent; providing information on the number of candidate cells to a cell abnormality detector; and receiving a list of candidate cells to be deactivated from the cell abnormality detector.

The at least one processor may further cause the NES controller to perform: receiving a second NES intent instructing an increase in network energy; generating a list of candidate cells to be activated in an order from a cell having a highest load to a cell having a lowest load among cells adjacent to deactivated cells based on the second NES intent; and transmitting a reactivation command to a second base station managing a fourth cell, so that the fourth cell adjacent to a third cell having the highest load among cells included in the list of candidate cells is reactivated.

The at least one processor may further cause the NES controller to perform: determining UEs to be handed over to the fourth cell among UEs served by the third cell; and transmitting handover instruction information to the second base station, so that handover commands are transmitted to the UEs to be handed over to the fourth cell.

The at least one processor may further cause the NES controller to perform: receiving a first quality of service (QoS) degradation (QSD) intent; in response to receipt of overloaded cell information for a second cell from a cell abnormality detector, generating a candidate UE list of UEs capable of handover from the second cell to adjacent third cells; determining a target cell for handover based on the first QSD for each of the UEs included in the candidate UE list, a target cell for a specific UE being one of the third cells; and transmitting a handover instruction command to second base station(s) managing the third cells, so that a handover command for handover to the determined target cell is transmitted to each of the UEs included in the candidate UE list.

According to exemplary embodiments of the present disclosure, a non-real-time RAN intelligent controller (RIC) and/or near-real-time RIC can perform controls to save network energy. In particular, a network energy saving (NES) controller can carry out network energy saving by activating and/or deactivating cells based on a required quality of service (QoS) level and NES level, while ensuring a QoS for a UE to the greatest extent possible. Moreover, the present disclosure can be applied not only when an O-RAN network architecture is supported but also when the O-RAN network architecture is not supported. Furthermore, the present disclosure can be applied even when only traffic steering is supported in the network. Since applications of the present disclosure can be implemented through xApp and/or rApp, they can be executed on a processor.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a structure of an O-RAN system and interfaces between components of the O-RAN system.

FIG. 4 is a conceptual diagram illustrating configuration and interfaces of nodes connected to an automated NES orchestrator.

FIG. 5 is a control flow diagram for network energy saving in an NES orchestrator.

FIG. 6A is a conceptual diagram illustrating configuration of nodes constituting an RAN intelligent controller for network energy saving, and FIG. 6B is a conceptual diagram illustrating an RAN that performs control on an RAN intelligent controller for network energy saving.

FIG. 7 is a flowchart for describing a control operation when an NES controller according to the present disclosure deactivates cells.

FIG. 8A is a partial flowchart for describing a control operation when an NES controller according to the present disclosure activates cells, and FIG. 8B is a remaining flowchart for describing the control operation when the NES controller according to the present disclosure activates cells.

FIG. 9 is a conceptual diagram of a system for saving network energy by interworking with a non-RT RIC when the NES controller according to the present disclosure is included in a near-RT RIC.

FIG. 10 is a conceptual diagram of a system for saving network energy by interworking with a near-RT RIC when an NES controller according to the present disclosure is included in a non-RT RIC.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

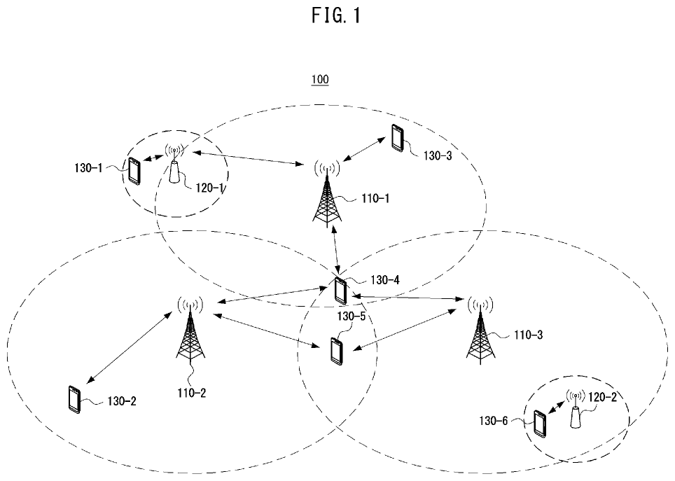

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

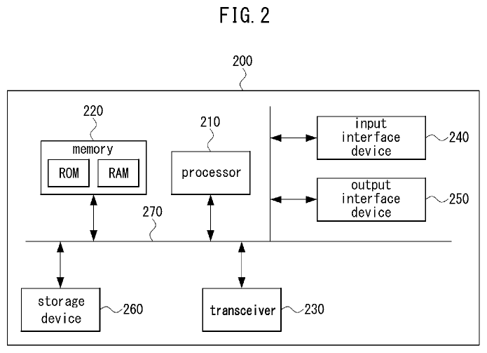

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, as described above, signal transmission and reception techniques for saving network energy or power in a wireless communication system are being discussed. In particular, for saving wireless network energy/power, a device and method for saving energy in an O-RAN system while not causing service degradation are required. In the present disclosure described below, a device and method for saving energy in an O-RAN system while not causing service degradation will be described.

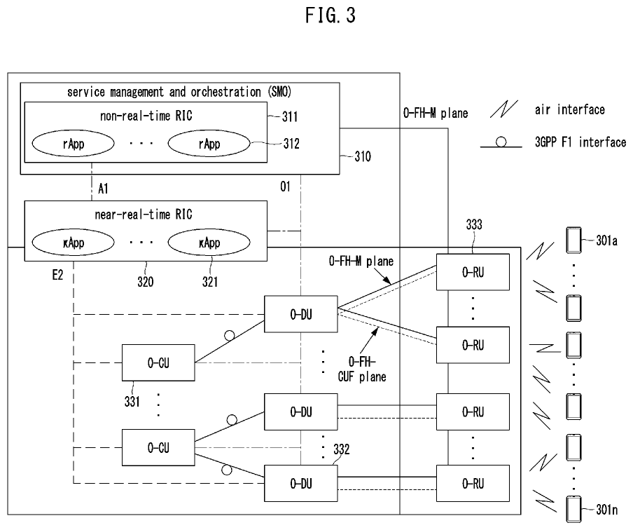

FIG. 3 is a conceptual diagram illustrating a structure of an O-RAN system and interfaces between components of the O-RAN system.

The O-RAN system illustrated in FIG. 3 is based on open interfaces that enable interaction between RAN intelligent controllers (RICs) and a RAN. First, the RAN may be composed of three logical functional units: open central units (CUs) (O-CUs) 331, open distributed units (DUs) (O-DUs) 332, and open radio units (RUs) (O-RUs) 333.

The O-CUs 331 constituting the RAN are centralized devices developed to process higher layer RAN protocols and may be connected to the O-DUs 332 via 3GPP midhaul F1 interfaces. The O-DUs 332 may be logical units that process lower protocol layers corresponding to radio link control (RLC), medium access control (MAC), and a portion of physical layers. The O-DUs 332 may interface with the O-RUs 333 that implement lower parts of the physical layers via fronthaul. In the O-RAN, the O-CUs 331, O-DUs 332, and non-functionally-split base stations (e.g. 5G gNBs and 4G eNBs) are referred to as ‘E2 nodes’, excluding the O-RUs 333.

The RICs may fine-tune RAN operations such as resource allocation, slicing, handover, mobility management, spectrum coexistence, and energy saving/efficiency through artificial intelligence (AI)/machine learning (ML) algorithms. The RICs may be composed of a non-real time (non-RT) RIC 311 whose control time is 1 second or more and a near-real time (near-RT) RIC 320 whose control time is 10 ms or more and less than 1 second, depending on a time scale of an RAN control loop.

The non-RT RIC 311 may be located within a service management and orchestration (SMO) node 310 of the O-RAN. The SMO 310 may support a management interface O1 for O-RAN components excluding the O-RUs 333, an interface A1 for interconnection between the non-RT RIC 311 and near-RT RIC 320, and an interface (i.e. open fronthaul management plane (O-FH-M plane)) for directly managing the O-RUs 333. Accordingly, the non-RT RIC 311 may collect RAN data through the O1 interface provided by the SMO 310, control operations of the O-CU 331/O-DU 332, and directly control the O-RUs 333 through the O-FH M plane interface when necessary.

The near-RT RIC 320 may receive AI/ML algorithms and control policies from the non-RT RIC 311 through the O1/A1 interface. In addition, the near-RT RIC 320 may receive all data related to the RAN through E2 interfaces. The near-RT RIC 320 may control the O-CUs 331/O-DUs 332, and indirectly control the O-RUs 333 through the O-FH M plane interfaces of the O-DUs 332 when necessary.

The O-RAN encourages anyone to develop applications (Apps) that perform RAN control functions in the RICs (i.e. non-RT RIC 311 and near-RT RIC 320) regardless of RIC manufacturers. Applications that perform RAN control functions may be referred to as ‘Apps’. In addition, Apps that operate in the non-RT RIC 311 and Apps that operate in the near-RT RIC 320 may be distinguished by a preceding suffix. For example, the Apps that operate in the non-RT RIC 311 may be referred to as ‘rApps’ 312 and the Apps that operate in the near-RT RIC 320 may be referred to as ‘xApps’ 321. The rApp and/or xApp may perform RAN control functions alone or in conjunction with other rApps/xApps.

In FIG. 3, the O-RUs 333 may communicate with terminals 301a, . . . , and 301m through air interfaces. In this case, channels transmitted through the air interfaces, which are used between the O-RUs 333 and terminals 301a, . . . , and 301m, may be channels used in 3GPP (e.g. PDCCH, PDSCH, PUCCH, PUSCH, etc.).

In the present disclosure described below, a method and device for transmitting and receiving signals for saving network energy or network power in the O-RAN system illustrated in FIG. 3 will be described. To this end, in the present disclosure, a method and device for turning on or off O-RUs constituting the O-RAN system in an intelligent and automated manner for saving network energy/power in the O-RAN system, or a method and device for activating and deactivating O-RUs in an intelligent and automated manner will be described. When O-RUs are deactivated, energy/power consumed in the network can be saved, but UEs served by the O-RUs may experience service degradation due to the deactivation of the O-RUs. Therefore, in the present disclosure, a method for controlling O-RUs for saving network energy/power while minimizing service degradation of UEs will be described.

Exemplary embodiments according to the present disclosure described below will describe a method for saving network energy/power in the O-RAN system and a RIC device for controlling the same. The O-CU/O-DU/O-RU according to the O-RAN system architecture may be applied to base stations of other wireless communication systems in addition to the 5G NR base station, such as base stations (or network nodes equivalent thereto) of LTE communication systems, 6G (sixth generation) communication systems, WiFi, etc. In addition, they may be applied to 5G gNB, 4G eNB, WiFi base stations in which base station functions are not split into CU/DU/RU. In particular, methods for reducing energy/power of a network by allowing a RIC device of the O-RAN, for example, a non-RT RIC device and/or a near-RT RIC device, to interwork with O-CU/O-DU/O-RUs or base stations will be described. In this case, the RIC device may have rApps/xApps installed (or mounted). The rApps/xApps may be applications programmed to perform control to reduce network power consumption according to the present disclosure.

In order to clearly and simply express operation methods of the present disclosure in the following description, the description will be made based on FIG. 3, which reflects a functional-split base station architecture. However, it may be apparent that the methods described below are applicable identically or similarly to non-functionally-split base stations.

The O-RAN system according to the present disclosure can centrally control a plurality of O-CUs/O-DUs/O-RUs or base stations through the non-RT RIC 311 and the near-RT RIC 320. In addition, the RIC devices 311 and 320 can intelligently control the RAN through AI/ML model training and inference. To this end, the RAN nodes (e.g. O-CUs 331, O-DUs 332, and O-RUs 333) can collect various data through the O1 interface and/or E2 interface, and the data collected from the RAN nodes may be provided to the RIC. The RIC can train and infer the AI/ML models using the collected data to generate control information for RAN control. In addition, the RIC can control the RAN nodes again through the O1 interface and the E2 interface using the generated control information.

The non-RT RIC 311 and the near-RT RIC 320 may control the RAN nodes by interworking with each other through the A1 interface. Alternatively, the non-RT RIC 311 and the near-RT RIC 320 may individually control the RAN nodes. Alternatively, the non-RT RIC 311 and the near-RT RIC 320 may individually control the RAN nodes by interworking with each other through the A1 interface.

According to the present disclosure, representative cell-level data items that RAN nodes need to collect and report to the RIC for network energy/power saving RAN control may include items listed in Table 1 below.

TABLE 1

| Items | Description |
|---|---|
| Energy consumption | Energy consumption of physical network function (E2 node) |
| Power consumption by O-RU | Average power consumption of physical network function (O-RU) |
| DL PDCP SDU data volume | The amount of PDCP PDU bits delivered from O-CU to O-DU |
| UL PDCP SDU data volume | The amount of PDCP PDU bits delivered from O-DU to O-CU |
| DL PRB usage per cell | DL PRB usage per cell |
| UL PRB usage per cell | UL PRB usage per cell |
| RSRQ per SSB per cell | RSRQ measurement values reported from UEs to serving cell |
| RSRP per SSB per cell | RSRP measurement values reported from UEs to serving cell |
| SINR per SSB per cell | SINR measurement values reported from UEs to serving cell |
| Number of active UEs per cell | The number of active UEs per cell |
| Cell location (x-pos, y-pos) | Location information of cell |
| . . . | . . . |

The items exemplified in Table 1 are cell-level collected data items in exemplary embodiments according to the present disclosure, and are merely an example to help understanding, and should not be interpreted as limited thereto. In other words, items for saving energy/power may be further added. In addition, the interfaces used to collect the items exemplified above may be the O1/E2 interface. However, the second item in Table 1, ‘power consumed by O-RU’, may be collected through the O-FM interface.

In addition to the cell-level data items exemplified in Table 1, it may be more preferable to additionally collect UE-level data items. According to the present disclosure, the RAN nodes may collect UE-level data items and report them to the RIC for network energy/power saving RAN control. Representative UE-level data items to be collected from the RAN nodes may include, for example, items as shown in Table 2 below.

TABLE 2

| Items | Description |
|---|---|
| UE_DL_PDCP_tput_Mbps | The amount of PDCP data transmitted to UE during a given |
| | time window |
| UE_DL_PRB_used | Average DL PRBs used for UE during TTI |
| UE_UL_PDCP_tput_Mbps | The amount of PDCP data received from UE during a given |
| | time window |
| UE_UL_PRB_used | Average UL PRBs used for US during TTI |
| UE_RS_SINR_dB_serving | RS SINR measurement value reported from UE to serving cell |
| UE_RSRP_dBm_serving | RSRP measurement value reported from UE to serving cell |
| UE_RSRQ_dB_serving | RSRQ measurement value reported from UE to serving cell |
| UE_RS_SINR_dB_nbr | RS SINR measurement value for neighboring cell, which is |
| | reported from UE |
| UE_RSRP_dBm_nbr | RSRP measurement value for neighboring cell, which is |
| | reported from UE |
| UE_RSRQ_dB_nbr | RSRQ measurement value for neighboring cell, which is |
| | reported from UE |
| UE location (x-pos, y-pos) | Location information of active UEs for each cell |
| . . . | . . . |

The items exemplified in Table 2 above are UE-level collection data items in exemplary embodiment according to the present disclosure, and are merely an example to help understanding, and should not be interpreted as limited thereto. In other words, items for saving energy/power may be further added. In addition, the interface used to collect the items exemplified above may be the O1/E2 interface. However, the second item in Table 2, ‘UE_DL_PRB_used’, may be collected through the O-FM interface.

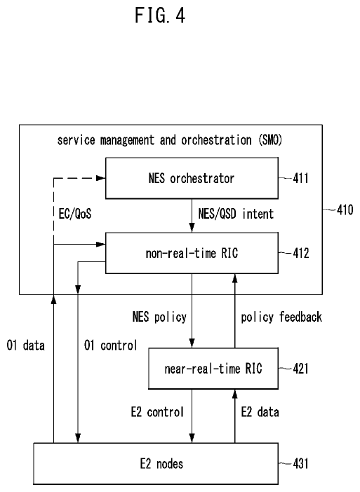

FIG. 4 is a conceptual diagram illustrating configuration and interfaces of nodes connected to an automated NES orchestrator.

Referring to FIG. 4, an SMO 410 may include an NES orchestrator 411 and a non-RT RIC 412. The SMO 410 according to the present disclosure has no additional difference from the SMO 310 illustrated in FIG. 3 except that it further has the NES orchestrator 411. In addition, the non-RT RIC 412 may have the same configuration and perform the same operations as described in FIG. 3, and may collect information of the items described in Tables 1 and 2. At least some of the operations performed in the non-RT RIC 412 may be controlled by rApps described in FIG. 3.

A near-RT RIC 421 may receive AI/ML algorithms and control policies from the non-RT RIC 412, and collect information for the AI/ML algorithms from E2 nodes 431 based on the control policies. In this case, the information collected by the near-RT RIC 421 may include at least some of information of the items exemplified in Table 1 and/or Table 2 above. At least some of the operations performed in the near-RT RIC 421 may be controlled by xApps.

The E2 nodes 431 may be O-CUs, O-DUs, non-functionally-split base stations (e.g. 5G gNBs and 4G eNBs), and nodes that perform operations similar to base stations in the wireless communication system, as described in FIG. 3. It should be noted that in FIG. 4, the E2 nodes 431 are exemplified to show that the present disclosure is applicable not only to the functionally-split network such as the O-RAN system but also to base stations of a non-functionally-split network. Therefore, although the E2 nodes 431 are exemplified as one block in FIG. 4, it should be noted that they can be understood as a set of nodes that can be controlled by the SMO 410 and/or near-RT RIC 421.

The NES orchestrator 411 may be located within the SMO 410 and may monitor the system's current ‘energy consumption (EC)’ and the users' quality of service (QoS) level through the O1 interface. The users' QoS level may be one or more of the items exemplified in Table 2 above. The NES orchestrator 411 may determine an energy saving level of the system by considering such monitoring data and a system operation intention of a system operator/manager. In addition, the NES orchestrator 411 may set an allowable degree of ‘QoS degradation (QSD)’ that may occur due to energy saving when determining the energy saving level. An NES intent/QSD intent configured in the above-described manner may be delivered to the non-RT RIC 412. Here, the NES intent may refer to the energy saving level, and the QSD intent may refer to QSD information.

The non-RT RIC 412 may receive the NES/QSD intent from the NES orchestrator 411 and identify the energy saving level and the allowable QoS degradation (QSD) that may occur due to the energy saving, which are set by the NES orchestrator 411. The non-RT RIC 412 may directly control the E2 nodes 431 based on the identified NES/QSD intent. When the non-RT RIC 412 directly controls the E2 nodes 431, the E2 nodes 431 may be controlled through the O1 interface. Alternatively, the non-RT RIC 412 may generate an NES policy suitable for the NES/QSD intent. The NES policy may be generated based on the NES/QSD intent, and the generated NES policy may be provided to the near-RT RIC 421. When the non-RT RIC 412 provides the NES policy to the near-RT RIC 421, the non-RT RIC 412 may deliver the NES policy to the near-RT RIC 421 through the A1 interface.

When the near-RT RIC 421 receives the NES policy from the non-RT RIC 412, the near-RT RIC 421 may perform control for network energy saving based on the received policy. In other words, the near-RT RIC 421 may collect data from the E2 nodes 431, and transmit control data for controlling the E2 nodes 431 based on the collected data and the NES policy received from the non-RT RIC 412 to the E2 nodes 431.

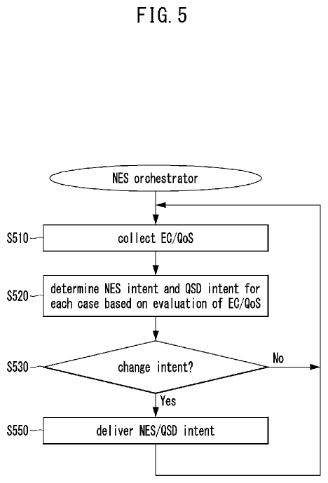

FIG. 5 is a control flow diagram for network energy saving in an NES orchestrator.

The operation of FIG. 5 may be the operation of the NES orchestrator 411 described in FIG. 4. Therefore, the network configuration as described in FIG. 4 may be applied. The E2 nodes 431 described in FIG. 4 may include O-CUs and O-DUs based on the O-RAN scheme. Alternatively, the E2 nodes 431 may be gNBs, which are 5G base stations that are not functionally-split, eNBs, which are base stations that are not functionally-split, and nodes that perform operations similar to base stations in the wireless communication system. In addition, the operation of FIG. 5 may be applied to cases where E2 nodes that are functionally-split based on the O-RAN scheme and E2 nodes that are not functionally-split are mixed.

In the exemplary embodiment according to FIG. 5, it is assumed that only the energy consumption (EC) of cells and the quality of service (QoS) of UEs are considered as network states to be monitored. In order to save network energy, other items may be considered in addition to the EC and QoS items. If other items are extended to be considered, those skilled in the art may consider additional items in the same or similar manner based on the contents of the present disclosure described below.

In the following description, the EC level will be described assuming that it is classified into three levels of ‘High’, ‘Medium’, and ‘Low’ for convenience of description. When the EC indicates ‘High’, it may correspond to a case that energy consumption is equal to or higher than a preset first threshold value. When the EC indicates ‘Low’, it may correspond to a case that energy consumption is equal to or lower than a preset second threshold value. Therefore, when the EC indicates ‘Medium’, it may correspond to a case that energy consumption is lower than the preset first threshold value and higher than the second threshold value.

In the present disclosure, for convenience of description, the QoS level will be described assuming that it is classified into two levels of ‘Good’ and ‘Bad’. This is merely for convenience of description, and the QoS level may be classified into three levels or four or more levels.

As described above, the EC levels and QoS levels may be determined based on at least one or more of the items exemplified in Table 1 and/or Table 2. The three levels of EC may be utilized as the NES intent, and the two levels of QoS may be utilized as the QSD intent. For example, an NES intent based on the three levels of EC may be composed of the following three pieces of indication information.
1) UP: Higher energy saving. In other words, it indicates deactivation of more cells.
2) —: Maintain the current state. In other words, it indicates maintenance of the current energy saving level.
3) Down: Lower energy saving. In other words, it indicates activation of at least some of deactivated cells.

A QSD intent based on the two levels of QoS may be composed of the following two indication information:
1) UP: Increase the acceptable QoS degradation level
2) —: Maintain the current QoS degradation level

The NES intent and QSD intent exemplified above are all examples to help understanding of the present disclosure. Therefore, the NES intent and/or the QSD intent may have more indication information. If the NES intent is composed of three pieces of information as described above, it may be indicated through two-bit information, and if the QSD intent is composed of two pieces of information as above, it may be indicated through one-bit information.

Based on the contents described above and the configuration of FIG. 4, the control operation of the NES orchestrator 411 of FIG. 5 will be described.

In step S510, the NES orchestrator 411 may collect EC information and QoS information from the E2 nodes 431. When the NES orchestrator 411 initially operates, the operation of the NES orchestrator 411 receiving EC information and QoS information from the E2 nodes 431 may simply be an operation of collecting information on the current state of the network. However, the flow chart of FIG. 5 shows a repeatedly performed operation. Therefore, if the operation according to the flow chart of FIG. 5 is repeatedly performed, in other words, after the control for energy saving of the network is performed, the EC information and QoS information that the NES orchestrator 411 receives from the E2 nodes 431 may be interpreted as feedback information for network energy saving. In this case, the EC information and QoS information may be received by the NES orchestrator 411 through the O1 interface.

In the configuration of FIG. 4, it is assumed that the NES orchestrator 411 receives the EC information and QoS information directly from the E2 nodes 431 through the O1 interface. However, depending on an implementation, the NES orchestrator 411 may also receive some of the EC information and/or QoS information directly from the E2 nodes 431 or through the non-RT RIC 412.

If the NES orchestrator 411 receives the EC information and QoS information directly from the E2 nodes 431, the information received through the O1 interface may be cell-specific EC information and QoS information and UE-specific EC information and QoS information. On the other hand, if the NES orchestrator 411 receives the EC information and QoS information through the non-RT RIC 412, the information received through the non-RT RIC 412 may be statistical information for the entire cells and the entire UEs.

In step S520, the NES orchestrator 411 mat evaluate the EC level and QoS level based on the received EC information and QoS information. This evaluation may be performed in six combinations as shown in Table 3 below when the EC level described above is determined in three levels and the QoS level is determined in two levels. In addition, in the present disclosure, the NES intent and the QSD intent may be determined as shown in Table 3 below based on the three EC levels and the two QoS levels.

TABLE 3

| | QoS | NES | QSD |
|---|---|---|---|
| EC level | level | intent | intent |
| High | Good | UP | UP |
| High | Bad | UP | — |
| Medium | Good | UP | UP |
| Medium | Bad | — | — |
| Low | Good | — | — |
| Low | Bad | — | — |

The EC levels and the QoS levels exemplified in Table 3 may be information acquired directly from step S510, and the NES intent and QSD intent may be determined based on the evaluation of EC and QoS as exemplified in Table 3 in step S520. In Table 3, ‘UP’ may mean increasement, and ‘—’ may mean performance maintenance. For example, the NES intent may indicate increasement (UP) or performance maintenance (—), and the QSD intent may also indicate increasement (UP) or performance maintenance (—). If the NES intent indicates ‘UP’, it may mean an indication to perform more network energy saving. On the other hand, if the QSD intent indicates ‘UP’, it may mean an indication to increase service quality.

The E2 nodes 431 may be nodes that directly provide services to terminals, as they are base stations that are not functionally-split or O-CUs and O-DUs that are functionally-split. In the wireless communication system, terminals may perform handover based on a quality of signals received from a serving cell, etc. However, in order to save network energy as in the present disclosure, if at least some of the E2 nodes 431 are activated (or turned on)/deactivated (or turned off), handover of the terminal may have to be performed due to the deactivation of the E2 nodes.

The NES orchestrator 411 may not allow handover of the terminal due to deactivation of a specific E2 node according to a policy. In other words, it may not allow QoS degradation of at least one UE due to deactivation of a specific E2 node. In this case, the QSD intent in Table 3 may be configured to indicate performance maintenance (‘—’).

In step S530, the NES orchestrator 411 may check whether there is a change in at least one intent among the NES intent and/or the QSD intent. For example, if the NES intent indicates UP or DOWN, it may correspond to a case that the NES intent has changed. In addition, if the QoS intent indicates UP, it may correspond to a case that the QSD intent has changed. If both the NES intent and the QSD intent indicate performance maintenance (‘—’), it may correspond to a case that there is no intent change. If there is an intent change, the NES orchestrator 411 may proceed to step S550, and if there is no intent change, the NES orchestrator 411 may proceed to step S510.

In step S550, the NES orchestrator 411 may change the policy based on the determined NES intent and/or QSD intent, and transmit the changed intent to the non-RT RIC 412.

Hereinafter, methods for the RIC (e.g. non-RT RIC 412 and/or near-RT RIC 521) to perform RAN control for network energy saving according to the NES intent and/or QSD intent will be described.

In the present disclosure described above and the present disclosure described below, three EC levels and two QoS levels are considered for clear and simple description. In other words, for convenience of description, the present disclosure does not consider various items and levels of detail. However, through the exemplary embodiment of the present disclosure, the NES orchestrator 411 may apply more diverse levels, that is, more diverse EC levels and more diverse QoS levels.

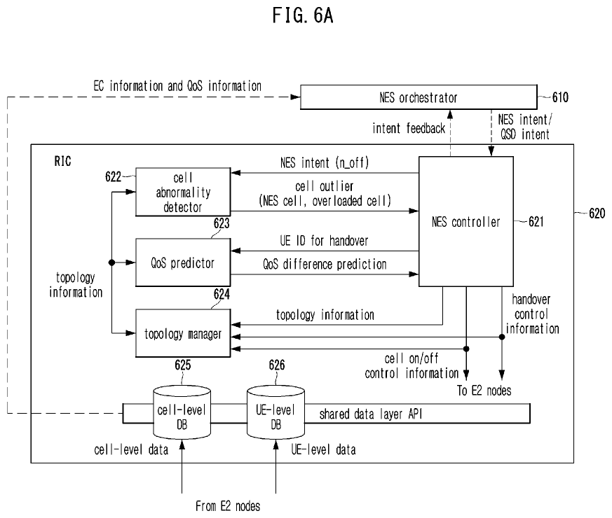

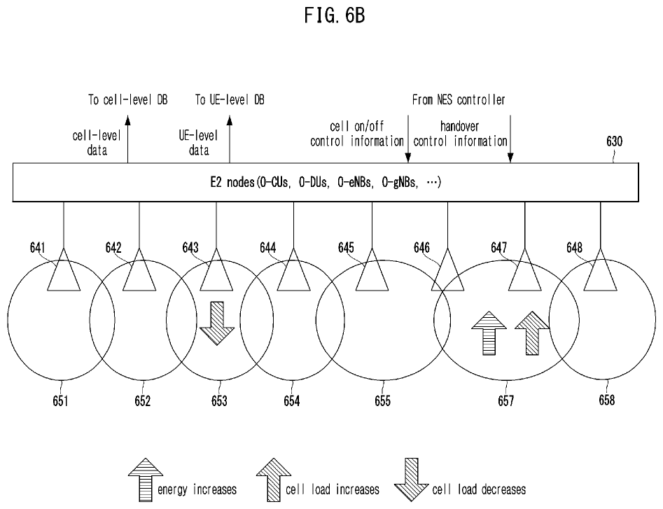

FIG. 6A is a conceptual diagram illustrating configuration of nodes constituting an RAN intelligent controller for network energy saving, and FIG. 6B is a conceptual diagram illustrating an RAN that performs control on an RAN intelligent controller for network energy saving.

FIG. 6A shows a configuration of nodes of an RIC for network energy saving, and FIG. 6B shows a configuration of an RAN that performs control on an RIC for network energy saving, which has components connected with those of FIG. 6A. It should be noted that in the present disclosure, two parts are illustrated as being divided in consideration of the complexity of the drawing.

First, referring to FIG. 6A, an NES orchestrator 610 and an RIC 620 are illustrated. The RIC may be the non-RT RIC 412 and/or near-RT RIC 421 described in FIG. 4. Network energy saving can be achieved by the NES orchestrator 610 directly controlling E2 nodes, controlling E2 nodes through the non-RT RIC 412, controlling E2 nodes through the near-RT RIC 421, or controlling E2 nodes using both the non-RT RIC 412 and near-RT RIC 421. Therefore, it should be noted that in FIG. 6A, the non-RT RIC and near-RT RIC are not distinguished, but are illustrated as the RIC. In other words, the RIC illustrated in FIG. 6A may be a non-RT RIC or a near-RT RIC.

The NES orchestrator 610 may have the same configuration and perform the same operation as the NES orchestrator 411 described in FIG. 4 above.

The RIC 620 may include an NES controller 621, a cell abnormality detector 622, a QoS predictor 623, a topology manager 624, a cell-level database (DB) 625, and a UE-level database (DB) 626.

The NES controller (NESC) 621 may receive an NES intent and/or a QSD intent from the NES Orchestrator 610. The NES intent may mean a network energy saving target, and the QSD intent may mean an allowable degree of user QoS degradation that results from cell deactivation. The NES controller 621 may determine cell deactivation/activation based on the maximum energy saving that satisfies the received NES intent and the minimum degree of user QoS degradation that complies with the received QoS intent. When deactivation of a specific cell is determined, the NES controller 621 may provide cell on/off control information and handover control information to the E2 nodes. In addition, when the NES controller 621 determines that a specific cell is to be deactivated, the NES controller 621 may provide, to the QoS predictor 623, a UE identifier (ID) for allowing a UE served by the corresponding cell to perform handover to another cell.

The topology manager (TM) 624 may access the cell-level DB 625 and the UE-level DB 626, and may manage UEs receiving cell-specific services and serving cell and neighboring cell information for each UE based on information stored in the cell-level DB 625 and information stored in the UE-level DB 626. In addition, the TM 624 may store information on an active/inactive state of each cell. Topology information including the stored information on the active/inactive state of each cell may be provided to the QoS predictor 623 and the cell abnormality detector 622.

The cell abnormality detector (CAD) 622 may detect cell abnormal values using cell-level data and an AI/ML model. Here, the ‘cell abnormal values’ may refer to abnormal values that are too far from other data observation values. In the present disclosure, a ‘cell outlier’ may refer to a cell that is a candidate for deactivation and/or is overloaded. The CAD 622 may receive the number n_off of deactivation candidate cells that have abnormal values, which are to be detected, from the NESC 621. When cell(s) having cell abnormal values are detected, the CAD 622 may detect the deactivation candidate cell(s) by removing overloaded cell(s).

An overloaded cell may be a cell that has a load that is greater than a load ratio set for a specific cell. When detecting an overloaded cell, the CAD 622 may periodically detect cell abnormal values without a special command or special input from the NESC 621 and select an overloaded cell based on a typical criterion. Selection of overloaded cells may be performed using an AI/ML model. As the AI/ML model, an AI/ML model that use a decision tree-based random forest technique, an AI/ML model that use an isolation forest technique, or an AI/ML model that includes an auto-encoder and performs deep learning may be used.

The QoS predictor (QSP) 623 may receive information on deactivation candidate cells, information on UEs served by the deactivation candidate cells, and information on neighboring cells of the UEs, and may predict a degree of QoS deterioration according to each cell to which each UE can be handed over. If a handover is performed, a UE ID for the handover may be received from the NES controller 621. In addition, the QoS predictor 623 may predict a QoS difference (i.e. difference between QoS before and after the handover) and report it to the NES controller 621.

The cell-level DB 625 may receive information on cell-level data items as described in Table 1 from the E2 nodes, and may store and manage the information. The UE-level DB 626 may receive information on UE-level data items as described in Table 2 from the E2 nodes, and may store and manage the information. The data stored in the cell-level DB 625 and the UE-level DB 626 may be time series data including timestamps. A shared data layer application programming interface (API) for accessing the cell-level DB 625 and the UE-level DB 626 may be provided. The NES controller 621, the cell abnormality detector 622, the QoS predictor 623, and the topology manager 624 may access the cell-level DB 625 and/or the UE-level DB 626 through the shared data layer API. In addition, the cell-level DB 625 and the UE-level DB 626 may provide EC information and QoS information to the NES orchestrator 610.

Referring to FIG. 6B, E2 nodes 630 may be connected to O-RUs 641, 642, 643, 644, 645, 646, 647, and 648 to form cells below. In FIG. 6B, only 8 O-RUs 641, 642, 643, 644, 645, 646, 647, and 648 are illustrated for convenience of description, but when forming an actual RAN, the number of O-RUs may be less than 8 or more than 8.

As illustrated in FIG. 6B, the E2 nodes 630 may be components such as O-CUs, O-DUs, O-eNBs, or O-gNBs. In FIG. 6B, the E2 nodes 630 are shown by type, and if the connection configuration with the O-RUs 641, 642, 643, 644, 645, 646, 647, and 648 is illustrated, the drawing may become very complicated, so it should be understood that the E2 nodes 630 are simplified.

As described in FIG. 6A, the E2 nodes 630 may receive cell on/off control information and handover control information from the NES controller 621. In addition, the E2 nodes 630 may collect cell-level data and UE-level data of the O-RU(s) they manage, respectively, and provide them to the cell-level DB 625 and the UE-level DB 626.

As described above, FIG. 6B illustrates 8 O-RUs 641, 642, 643, 644, 645, 646, 647, and 648 controlled by the E2 nodes 630. This diagram assumes that each of the 8 O-RUs 641, 642, 643, 644, 645, 646, 647, and 648 serves one cell. Therefore, the first O-RU 641 configures a first cell 651, the second O-RU 642 configures a second cell 652, the third O-RU 643 configures a third cell 653, the fourth O-RU 642 configures a fourth cell 654, the fifth O-RU 645 configures a fifth cell 655, the seventh O-RU 647 configures a seventh cell 657, and the eighth O-RU 648 configures an eighth cell 651.

In FIG. 6B, the sixth O-RU 646 is in a deactivated state, and may not configure a cell. Therefore, the fifth O-RU 645 and the seventh O-RU 647, which are adjacent cells of the sixth O-RU 646, may configure the fifth cell 655 and the seventh cell 657 to cover a cell area of the sixth O-RU 646.

As exemplified in FIG. 6A described above, the NES orchestrator 610 and the NES RIC 620 may determine cells that can be additionally deactivated. In the example of FIG. 6B, the third cell 653 managed by the third O-RU 643 may correspond to a case where a cell load decreases. In addition, a case where a cell load increases in the seventh cell 657 managed by the seventh O-RU 647 and the energy of the seventh O-RU 647 increases is exemplified.

As exemplified in FIG. 6B, since the cell load for the third O-RU 643 is decreased, the NES RIC 620 may configure the third O-RU 643 to be deactivated. Specifically, the NES controller 621 of the NES RIC 620 may configure the third O-RU 643 to be deactivated. The NES controller 621 may transmit a deactivation command (or deactivation indication information) for the third O-RU 643 to the O-CU or base station managing the third O-RU 643 to deactivate the third O-RU 643. In other words, the NES RIC 620 may provide cell on/off control information to the E2 nodes 630 to deactivate the third O-RU 643. Accordingly, the E2 nodes 630 may deactivate the third O-RU 643 and simultaneously transmit handover command(s) to UE(s) camped on the third O-RU 643 so that the UE(s) are handed over to adjacent cells. In addition, the E2 nodes 630 may extend the cells of the second O-RU 642 and the fourth O-RU 644, which are adjacent O-RUs of the third O-RU 643, to the area of the third cell 643 covered by the third O-RU 643. Through this, the RIC may reduce service degradation of the UE(s) while saving energy consumed in the network.

On the other hand, since the seventh O-RU 647 is overloaded and the energy consumed in the seventh O-RU 647 is increasing, the RIC 620 may decide to activate the sixth O-RU 646 again. The RIC 620 may provide cell on/off control information to the E2 nodes 630 to reactivate the sixth O-RU 646. Since the sixth cell is configured when the sixth O-RU 646 is activated, the E2 nodes 630 may instruct UEs located in the area of the sixth cell and served by the seventh O-RU 647 to be handed over to the sixth cell configured by the sixth O-RU 646.

Through this, the cell load of the seventh O-RU 647 may be reduced. In addition, the UEs served by the seventh O-RU 647 may be handed over to the sixth cell configured by the sixth O-RU 646 without QoS deterioration, and may be served by the sixth cell.

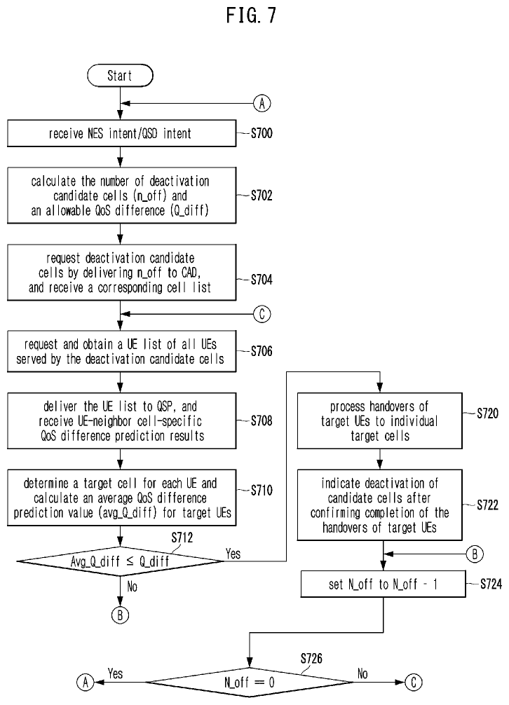

FIG. 7 is a flowchart for describing a control operation when an NES controller according to the present disclosure deactivates cells.

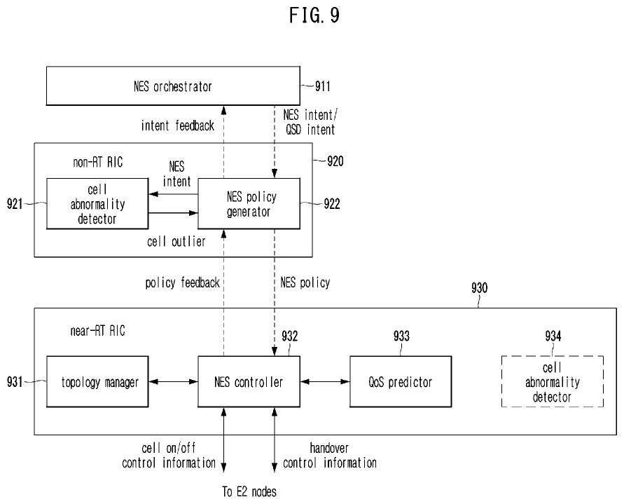

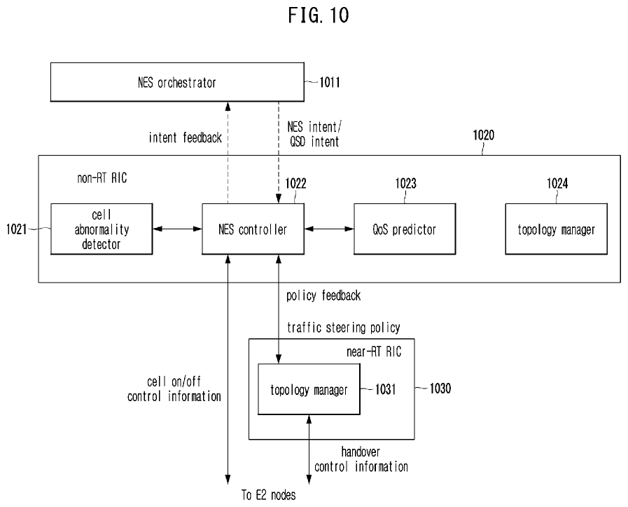

As an NES controller performing the operation of FIG. 7, the NES controller 621 described in FIG. 6A above may be assumed. According to the example of FIG. 6A, the RIC where the NES controller 621 is located may be a non-RT RIC or a near-RT RIC. Even when the NES controller has a different configuration from the RIC illustrated in FIG. 6A, the NES controller may operate in the same or similar manner as described below. For example, it should be noted that even when the NES controller is arranged within a non-RT RIC as in FIG. 9 to be described later or within a near-RT RIC as in FIG. 10 described later, the same operation as described in FIG. 7 may be performed. Therefore, in describing FIG. 7 below, the control operation will be described using the configurations described in FIG. 6A and FIG. 6B for convenience of understanding.

In addition, the NES controller 621 may include all of the components described in FIG. 2. In another example, the NES controller 621 may include only some of the components described in FIG. 2. In another example, the NES controller 621 may include some of the components described in FIG. 2 and additional component(s). Here, the additional components may be interfaces for the operator to load, install, mount and/or execute xApps and/or rApps.

In step S700, the NES controller 621 may receive an NES intent and/or QSD intent from the NES orchestrator 610. The NES intent and/or QSD intent may be determined based on an EC level and a QoS level as described above in Table 3. According to the example of Table 3, the NES intent may indicate increasement (UP) or performance maintenance (—), and the QSD intent may indicate increasement (UP) or performance maintenance (—). In the exemplary embodiment of FIG. 7, since the control operation when a cell is deactivated is described, it is assumed that the NES intent indicates increasement (UP). In other words, it is assumed that the network energy saving is further indicated. The NES controller 621 may confirm that the NES intent indicates increasement (UP) and may proceed to step S702.

Meanwhile, the NES intent may be expressed in the form of increasement (UP) or performance maintenance (—), but other schemes are also possible. For example, the NES intent may be presented as a specific numerical value, such as an energy saving value in Watts. If the NES intent is set to a specific power value, such as a Watt unit, the NES controller 621 may calculate the number of cells (or O-RUs) to be deactivated in response to the power value obtained from the NES intent. As another example, the NES intent may be indicated as the number of cells (or O-RUs) to be deactivated.

In the present disclosure, for convenience of description, it is assumed that the NES intent indicates only increasement (UP) or performance maintenance (—) as described in Table 3 above. In addition, if the NES intent indicates increasement (UP), it is assumed that a number of cells (or O-RUs) equal to a predetermined number of n_off are additionally deactivated.

The NES controller 621 may also interpret the QSD intent to calculate an allowable QoS degradation degree Q_diff. In this case, the QSD intent may also be configured in various ways in the same manner as the NES intent.

In step S702, since the NES intent indicates increasement (UP), the NES controller 621 may calculate the number of candidate cells to be deactivated (n_off) or the number of candidate O-RUs to be deactivated (n_off) so as to increase the network energy saving effect. In addition, the NES controller 621 may calculate an allowable QoS difference (Q_diff) based on the QSD intent.

According to a result of the calculation of step S702, the NES controller 621 may indicate a maximum number of cells (or O-RUs) to be deactivated, which is n_off. In this case, the NES controller 621 needs to determine which cells among the cells to deactivate. Therefore, the NES controller 621 may determine to deactivate arbitrary cells, or may select cells to be deactivated according to specific conditions. The present disclosure additionally proposes a method for selecting cells that maximize the network energy saving effect while minimizing QoS degradation of the UE.

In step S704, the NES controller 621 may request a list of deactivation candidate cells while delivering the value of n_off, which means the number of candidate cells to be deactivated or the number of candidate O-RUs to be deactivated, to the CAD 622. n_off may mean the number of candidate cells (or O-RUs) to be deactivated as described above.

In step S704, the CAD 622 may receive the number of deactivation candidate cells from the NES controller 621, and may generate deactivation candidate cell list information corresponding to the received number of deactivation candidate cells. The deactivation candidate cell list information may be determined based on the number of cells (n_off). In addition, in step S704, the CAD 622 may transmit the generated deactivation candidate cell list information to the NES controller 621. Accordingly, the NES controller 621 may receive the deactivation candidate cell list information from the CAD 622. The NES controller 621 may obtain the number of cells (N_off) that can be deactivated from the deactivation candidate cell list information. In this case, N_off may be the same value as n_off. As another example, N_off may be another value close to n_off.

Here, it is important to note that the deactivation candidate cells informed from the CAD 622 cannot be deactivated immediately. This is because there may be UEs served by the deactivation candidate cells. Therefore, the NES controller 621 needs to be able to safely move the UEs served by the deactivation candidate cells to other neighboring cells. In other words, the NES controller 621 needs to allow the UEs served by the deactivation candidate cells to be handed over. In this case, the NES controller 621 needs to ensure that QoS deterioration of the UEs after performing the handover satisfies the QSD intent.

In step S706, the NES controller 621 may request a UE list of all UEs served by the deactivation candidate cells from the topology manager 624 and obtain the UE list of all UEs served by the deactivation candidate cells from the topology manager 624.

In step S708, the NES controller 621 may request a UE-neighboring cell-specific QoS difference prediction result (i.e. a result of predicting a difference between QoS for each UE before and after a handover of the UE to each cell) from the QoS predictor 623 by providing information on all UEs served by the deactivation candidate cells. Accordingly, the QoS predictor 623 may receive the information on all UEs served by the deactivation candidate cell and a request for the UE-neighboring cell-specific QoS difference prediction result from the NES controller 621.

The QoS predictor 623 may check whether there are cell(s) to which all UEs served by the deactivation candidate cells can be handed over based on the information received from the NES controller 621. In addition, the QoS predictor 623 may determine a result of predicting QoS values after all UEs served by the deactivation candidate cells are handed over (i.e. UE-neighboring cell-specific QoS difference prediction result). The QoS predictor 623 may provide a response message including information on whether handover is possible for all UEs and the UE-neighboring cell-specific QoS difference prediction result to the NES controller 621.

The procedure between the NES controller 621 and the QoS predictor 623 performed in step S706 may be performed in various ways. For example, the following methods may exist.

First, when the NES controller 621 notifies the QoS predictor 623 of the deactivation candidate cells, the QoS predictor 623 may identify the UEs using the topology manager 624 and obtain the UE-neighboring cell-specific QoS difference prediction information for the UEs. The QoS predictor 623 may transmit the obtained UE-neighboring cell-specific QoS difference prediction information to the NES controller 621 at one time or multiple times.

Second, the NES controller 621 may obtain a list of UEs served by the deactivation candidate cells using the topology manager 624 and then transmit information on the individual UEs to the QoS predictor 623. Then, the QoS predictor 623 may transmit UE-neighboring cell-specific QoS difference prediction information for each UE to the NES controller 621. This procedure may be repeated for all UEs within the list.

Third, the NES controller 621 may obtain a list of UEs served by the deactivation candidate cells using the topology manager 624. Then, the NES controller 621 may transmit the obtained UE list to the QoS predictor 623. The QoS predictor 623 may obtain UE-neighboring cell-specific QoS difference prediction information for each UE included in the received entire UE list, and may transmit them to the NES controller 621 at one time.

Here, the UE-neighboring cell-specific QoS difference prediction information for each UE may be calculated in the following manner. A target cell (neighboring cell) for the handover may be determined for each UE. Therefore, the QoS predictor 623 may calculate a QoS prediction value in the corresponding cell (a neighboring cell before the handover) after the corresponding UE has handed over. The QoS value in the current serving cell of the UE may be a known value. Here, if the QoS prediction value in the corresponding cell after the handover of the UE is QoS_pred, the QoS value in the current serving cell of the UE is QoS_serv, and a QoS difference prediction value per UE-neighboring cell is QoS_diff, the UE-neighboring QoS difference prediction value QoS_diff may be calculated as in Equation 1 below.

$$QoS\_diff = QoS\_serv - QoS\_pred \qquad [ Equation 1 ]$$

If the QoS predictor 623 only performs prediction of QoS_pred, the QoS predictor 623 may report only the QoS prediction value (QoS_pred) in the corresponding cell after the handover to the NES controller 621. Then, the NES controller 621 may obtain the QoS value QoS_serv in the current serving cell of the UE and calculate the UE-neighboring cell-specific QoS difference prediction value QoS_diff. As described above, the UE-neighboring cell-specific QoS difference prediction value QoS_diff may be obtained in the QoS predictor 623 or in the NES controller 621. Since the QoS predictor 623 and/or the NES controller 621 can access the cell-level DB 625 and the UE-level DB 626 through the shared data layer API, both the QoS predictor 623 and the NES controller 621 may obtain the QoS value QoS_serv in the current serving cell of the UE. Accordingly, the UE-neighboring cell-specific QoS difference prediction value QoS_diff may be calculated by either the QoS predictor 623 or the NES controller 621.

In the present disclosure, for convenience of description, it is assumed that the QoS predictor 623 calculates all information and provides only a result to the NES controller 621.

In step S708, the NES controller 621 may receive the response message including information on whether handover is possible for all UEs served by the deactivation candidate cells and the UE-neighboring cell-specific QoS difference prediction results from the QoS predictor 623. The NES controller 621 may perform the subsequent steps only when the information on whether handover is possible for all UEs served by the deactivation candidate cells indicates that handover is possible. If the information on whether handover is possible for all UEs served by the deactivation candidate cells indicates that handover is impossible, the NES controller 621 may exclude specific cell(s) from the deactivation candidate cells or terminate the routine of FIG. 7.

In step S710, the NSE controller 621 may determine a target cell for each UE and calculate an average QoS difference prediction value (avg_Q_diff) of target UEs.

The NES controller 621 may determine a handover target cell for each UE in various ways based on the UE-neighboring cell-specific QoS difference prediction values QoS_diff. For example, the NES controller 621 may determine a neighboring cell with the smallest QoS_diff as a target cell. Alternatively, the NES controller 621 may randomly select a target cell among neighboring cells with QoS_diff below a certain level. The former method may be a method of selecting a target cell that can provide the best performance from the UE's perspective. However, there is a risk that a load of the target cell may suddenly increase because UEs to be handed over move to the same target cell. The latter method has an advantage of being able to distribute handovers of UEs to prevent the former risk. On the other hand, the latter method has a disadvantage that the QoS deterioration of the UE may be relatively large. The present disclosure is not limited to a specific one among various methods including the method for determining a handover target cell for each UE.

When a target cell for each UE is determined, the NES controller 621 may calculate a QoS difference value q_diff as shown in Equation 2 below.

$$q\_diff = QoS\_serv - QoS\_pred \_target \qquad [ Equation 2 ]$$

In Equation 2, QoS_pred_target may be an expected QoS value when the UE is handed over to the target cell. In other words, the QoS_pred received from the QoS predictor 623 may have a form be being replaced with QoS_pred_target. In the above description, the QoS predictor 623 may provide all QoS_pred for the adjacent cells of the cell serving the UE to the NES controller 621. Therefore, if a target cell is determined based on one of the two methods described above or one of other methods not described in the present disclosure, the corresponding cell becomes the target cell, and thus the QoS_pred of the cell may be set to QoS_pred_target.

Then, the NES controller 621 needs to determine whether to deactivate the deactivation candidate cells. There may be various methods for determining such deactivation candidate cells as inactive cells. In order to apply a stricter criterion for user QoS degradation, the NES controller 621 may determine a corresponding deactivation candidate cells as inactive cells only when QoS degradation degrees q_diff values of all UEs are less than or equal to the allowable QoS difference value Q_diff. As another example, emphasizing the energy saving aspect, the NES controller 621 may determine the corresponding deactivation candidate cells as inactive cells when the average q_diff value avg_Q_diff of the related UEs is less than or equal to the allowable QoS difference value Q_diff. The present disclosure described below may assume a case where the average value is used.

In addition, although not specified in step S710 of FIG. 7, description will be made on a premise that all UEs satisfy the minimum guaranteed QoS in order to guarantee user QoS. In other words, not only the q_diff value but also the minimum guaranteed QoS of the corresponding UE are considered together.

In step S712, the NES controller 621 may compare the average QoS difference prediction value (avg_Q_diff) of the target UEs with the allowable QoS difference (Q_diff). In FIG. 7, if the avg_Q_diff value does not satisfy the condition of being less than or equal to Q_diff, the NES controller 621 may decide not to deactivate the corresponding deactivation candidate cells. Therefore, the UEs served by the corresponding cells do not need to be handed over to the adjacent cells. Therefore, if the average QoS difference prediction value avg_Q_diff of the target UEs is smaller than the allowable QoS difference value Q_diff, the NES controller 621 may proceed to step S720. On the other hand, if the average QoS difference prediction value avg_Q_diff of target UEs is greater than the allowable QoS difference value Q_diff, the NES controller 621 may proceed to step S724 to prevent deactivation of the corresponding cells and handover of the UEs.

Steps S708, S710, and S712 described above may be operations for determining whether handover is possible for UEs served by the deactivation candidate cells.

In step S720, the NES controller 621 may process handover to individual target cells for the target UEs. In addition, the case where the NES controller 621 proceeds to step S720 is when the average QoS difference prediction value avg_Q_diff is within the allowable QoS difference value as described above. Therefore, the cells serving the UEs need to be deactivated. When cells providing services to the UEs are deactivated, the UEs need to perform all procedures anew, starting from the operation of searching for a new cell, which not only causes a waste of radio resources but also increases the load on the E2 nodes such as the base station. Therefore, it may be preferable for the NES controller 621 to handover the UEs to a target cell among the adjacent cells before deactivating the deactivation candidate cells. Accordingly, when the NES controller 621 performs handover processing for the target UEs to individual target cells, the NES controller 621 may provide handover control information to the E2 nodes 630. Here, the handover processing may mean an operation in which the NES controller 621 instructs the UE served by the deactivation target cell to handover to the target cell. The handover indication from the E2 node to the UE may be an operation such as transmitting a radio resource control (RRC) reconfiguration message.

Accordingly, the NES controller 621 may transmit handover control information to the corresponding E2 node among the E2 nodes 630 as illustrated in FIG. 6A. Accordingly, the handover control information may include target UE information and target cell information.

When an E2 node among the E2 nodes 630 receives the handover control information for a specific UE from the NES controller 621, the E2 node may transmit a handover command including target cell information to the specific UE to which the handover is directed. Through this, the UE receiving the handover command may perform a handover to a target cell directed by the NES controller 621. When the handover is completed, the UE may transmit a handover complete message to the E2 node. Accordingly, the E2 nodes may transmit handover complete information to the NES controller 621 when the handover of the specific UE is completed.

In step S722, the NES controller 621 may check whether the handovers of the target UEs are completed based on the information received from the E2 nodes 630. When the handovers of all the target UEs are completed, the NES controller 621 may instruct the E2 nodes to deactivate the corresponding target cell (or O-RU). According to the description in FIG. 6B above, the sixth O-RU 646 may be deactivated (or turned off) according to the cell deactivation indication.

In step S724, the NES controller 621 may exclude the deactivated cell from the deactivation cell list received from the CAD 622. Then, in step S726, the NES controller 621 may check whether there are additional deactivation target cell(s) other than the deactivated cell. In this case, if the deactivation cell list information received from the CAD 622 indicates simply the number of cells, as illustrated in FIG. 7, the NES controller 621 may decrease the N_off value by one in step S724. Then, in step S726, the NES controller 621 may check whether the N_off value is zero (0)

If the N_off value is zero or there are no more cells to be deactivated, the NES controller 621 may proceed to step S700. On the other hand, if there is an additional cell to be deactivated, the NES controller 621 may proceed to step S706. In other words, if there is an additional cell to be deactivated, the routine described above may be repeatedly performed.

Meanwhile, the UE handover indication and cell deactivation indication described as transmitted by the NES controller 621 to the E2 node may be transmitted in different O-RAN standard interfaces (e.g. O1, O-FH M-plane, or E2) depending on whether the NES controller 621 is implemented in a non-RT RIC or a near-RT RIC. If the NES controller 621 is implemented in a non-RT RIC, the O1 interface or the O-FH M-plane interface may be used to transmit the UE handover indication and cell deactivation indication. On the other hand, if the NES controller 621 is implemented in a near-RT RIC, the E2 interface may be used to transmit the UE handover indication and cell deactivation indication.

Some of the steps described in FIG. 7 may be omitted or not performed. For example, if the QSD intent is not considered, steps S708, S710, and S712 may not be performed. However, if the QSD intent is not considered, the service quality of the UE may deteriorate rapidly, so it may be more preferable to consider the QSD intent.

In addition, steps S702 and S704 may be performed at once. For example, if the number of cells (or O-RUs) to be deactivated for the NES intent is pre-defined in a table, the number of cells to be deactivated may be obtained without the calculation of step S702.

On the other hand, if deactivation is performed for at least one E2 node based on the control of FIG. 7, the NES controller 621 may control adjacent cells (or RUs) to increase signal transmission ranges to the deactivated cells. For example, as illustrated in FIG. 6B, if the sixth O-RU (or cell) is deactivated, the cells 655 and 657 of the fifth O-RU 645 and the seventh O-RU 647 may be expanded to cover the cell range that should be configured by the sixth O-RU (or cell).

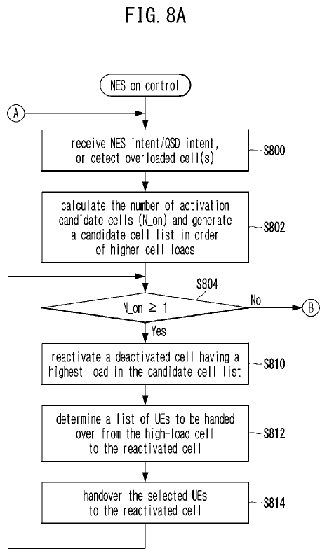

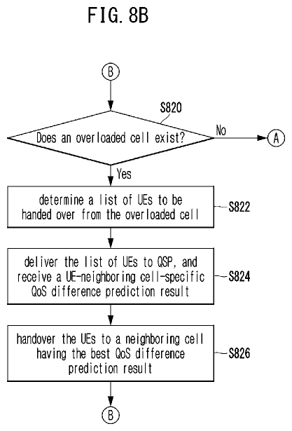

FIG. 8A is a partial flowchart for describing a control operation when an NES controller according to the present disclosure activates cells, and FIG. 8B is a remaining flowchart for describing the control operation when the NES controller according to the present disclosure activates cells.

As an NES controller performing operations of FIG. 8A and FIG. 8B, the NES controller 621 described in FIG. 6A is assumed. According to the example of FIG. 6A, an RIC where the NES controller 621 is located may be a non-RT RIC or a near-RT RIC. Even if the NES controller has a different configuration from the RIC as illustrated in FIG. 6A, the NES controller may operate in the same or similar manner as described below. For example, it should be noted that the same operations as described in FIG. 8A and FIG. 8B may be performed even when the NES controller is located in a non-RT RIC as in FIG. 9 to be described later, or when the NES controller is located in a near-RT RIC as in FIG. 10 to be described later. Therefore, in describing FIG. 8A and FIG. 8B below, for convenience of understanding, the control operation will be described using the configuration described in FIG. 6A and FIG. 6B.

In step S800, the NES controller 621 may receive an NES intent and/or a QSD intent from the NES orchestrator 610 or may receive cell overload information from the cell abnormality detector 622. In the present disclosure, events for activating deactivated cells are classified into two types.

One event for activating deactivated cells may be a case in which an NES intent that lowers an NES level is received. Table 3 only exemplifies cases where an NES intent indicates increasement (UP) or maintenance (—). In the exemplary embodiment of FIG. 8A and FIG. 8B, it will be described assuming that an NES intent has three cases: increasement (UP), maintenance (—), and decrement (DOWN).

Another event for activating a deactivated cell may be a case in which existing activated cells become overloaded due to deactivated cells.

The exemplary embodiments of FIGS. 8A and 8B will describe a method of activating a portion of deactivated cells based on at least one of the two events to match the adjusted NES level or offload the loads of the overloaded cells. By reactivating a portion of the deactivated cells, the QoS of the UE may ultimately be improved.

In step S802, the NES controller 621 may select candidate cells (or O-RUs) to be activated from among the deactivated cells (O-RUs). Then, the NES controller 621 may calculate the number of cells (or O-RUs) to be activated. In the following description, the number of candidate cells (or O-RUs) to be activated is assumed to be N_on. If detection of overloaded cell(s) is triggered in step S800, the value of N_on may be set to zero (0). This makes it possible to identify whether the detection in step S800 is trigged for cell activation by an NES intent and/or QSD intent or for cell activation by overloaded cell(s). In addition, the NES controller 621 may configure a candidate cell list in an order of cells with high cell load to cells with low cell load among activated cells adjacent to the currently deactivated cell(s). In this case, the cells included in the candidate cell list may be cells having a higher load than a normal cell load. For example, the candidate cell list may be configured to include only cells having a load ratio value higher than an average load ratio of cells not adjacent to the currently deactivated cell(s).

In step S804, the NES controller 621 may check whether the value of Non is 1 or more. A case where the value of N_on is 1 or more may correspond to a case where some cells among the deactivated cells need to be reactivated based on the NES intent as described above. On the other hand, a case where the value of N_on value is not 1 or more (e.g. the value of Non is 0) may correspond to an operation due to detection of overloaded cell(s). If the value of N_on is 1 or more based on the result of step S804, the NES controller 621 may proceed to step S810, and if the value of N_on is 0, the NES controller 621 may proceed to step S820.

In step S810, the NES controller 621 may select the highest-ranked cell from the candidate cell list. As described above, the highest-ranked cell from the candidate cell list may be a cell with the highest load among the cells included in the candidate cell list. Therefore, the highest-ranked cell may be selected from the candidate cell list to reactivate the deactivated cell. When reactivating the deactivated cell, the NES controller 621 may transmit a deactivated cell reactivation indication command (or indication information) to a base station (or O-CU or O-RU) managing the deactivated cell. When reactivating a specific deactivated cell from the candidate cell list, the NES controller 621 may delete the reactivated cell from the deactivated cell list. This may result in decreasing the value of N_on by one. In other words, the value of N_on may be reset to ‘N_on−1’.

In step S812, the NES controller 621 may determine a list of UEs to be handed over from the high-load cell to the reactivated cell. The NES controller 621 may generate the list of UEs to be handed over to the reactivated cell as follows. The NES controller 621 may request the QoS predictor 623 for information on UEs whose QoS is expected to be improved when handed over from the high-load cell to the reactivated cell. To this end, the NES controller 621 may generate a list of all UEs included in the high-load cell and deliver it to the QoS predictor 623. Alternatively, the NES controller 621 may request the QoS predictor 623 for information on UEs whose QoS is expected to be improved when handed over from the high-load cell to the reactivated cell by delivering information on the high-load cell to the QoS predictor 623. Alternatively, the NES controller 621 may select UE(s) with low QoS in the high-load cell. Alternatively, the NES controller 621 may request QoS prediction information only for UEs with low QoS in the high-load cell when handed over to the reactivated cell.

In response, if the QoS predictor 623 provides the requested information to the NES controller 621, the NES controller 621 may determine a list of UEs to be handed over.

In step S814, the NES controller 621 may provide handover control information to instruct handover to the reactivated cell (or O-RU) for the UEs included in the UE list to an E2 node that manages the overloaded cell (or O-RU) among the E2 nodes 630. Accordingly, the E2 node may transmit a handover command to the UEs to instruct the handover to the reactivated cell (or O-RU). Therefore, the UE(s) included in the UE list may perform the handover to the reactivated cell.

Thereafter, the NES controller 621 may proceed to step S804 and repeat the operation described above. In FIG. 8A, for convenience of description, a procedure is described in which a load of the highest-load cell is offloaded to the reactivated cell and then N_on is reset to (N_on−1). This operation may offload the next higher-load cell until the load of the reactivated cell reaches a certain level. This offloading for the high-load cells through selection of reactivated cells may be repeated until N_on becomes 0.

If the result of step S804 indicates N_on=0, the process may proceed to step S820. In step S820, the NES controller 621 may check whether overloaded cell(s) exist. The presence of overloaded cell(s) may correspond to a case where overloaded cell information is received from the cell abnormality detector 622. If there is an overloaded cell, the NES controller 621 may proceed to step S822. On the other hand, if there is no overloaded cell, the NES controller 621 may wait for step S800.

In step S822, the NES controller 621 may decide to offload the load of the overloaded cell to a neighboring active cell without the cell reactivation process. To this end, UEs with QoS below a certain threshold from a UE with the worst QoS in the overloaded cell may be selected. The UE(s) selected as described above may be UE(s) to be handed over to an adjacent other cell. Accordingly, the NES controller 621 may determine a UE list having information on UEs that are determined to require handover.

In step S824, the NES controller 621 may request a QoS difference prediction result when handed over to a neighboring cell by transmitting the UE list to the QoS predictor 623. Accordingly, the QoS predictor 623 may calculate a difference between a predicted QoS value in the neighboring cell when handed over to the neighboring cell and a QoS value in the current cell for each UE included in the UE list, and transmit the result to the NES controller 621. Accordingly, the NES controller 621 may receive the UE-neighboring cell-specific QoS difference prediction result from the QoS predictor 623. Based on the UE-neighboring cell-specific QoS difference prediction result, the NES controller 621 may determine the best neighboring cell to which the UE is to be handed over.

In step S826, the NES controller 621 may transmit handover control information to the E2 nodes so that individual UEs are handed over to the neighboring cell with the best QoS difference prediction result. In this case, the neighboring cell with the best QoS difference prediction result may correspond to a case where the QoS difference prediction result is q_diff<0, and thus the QoS is improved through the handover. Step S826 may be repeatedly performed until the load of the overloaded cell is lowered within a preset load threshold value.

Although not exemplified in FIG. 8B, if the overloaded cell(s) are not continuously resolved, the NES controller 621 may notify the NES orchestrator 610 that the overloaded cell(s) are continuously occurring through intent feedback. Accordingly, the NES orchestrator 610 may recognize that the overloaded cell(s) are continuously occurring through the intent feedback. If the overloaded cell(s) are identified as continuously occurring through the intent feedback, the NES orchestrator 610 may update the NES intent that adjusts the NES level and transmit it to the NES controller 621, thereby causing reactivation of the deactivated cell(s).

The operation of the NES controller 621 according to the present disclosure has been described with reference to FIG. 7, FIG. 8A, and FIG. 8B. Hereinafter, the operation of the topology manager 624 will be described.

As described above, the topology manager 624 may access the cell-level DB 625 and the UE-level DB 626, and may manage UEs receiving cell-specific services and serving cell and neighboring cell information for each UE based on information stored in the cell-level DB 625 and information stored in the UE-level DB 626. The cell-specific NES state and cell-specific served UE list managed by the topology manager 624 may be exemplified as in Table 4 below based on the previously described FIG. 6B.

TABLE 4

| | NES | |
|---|---|---|
| Cell ID | state | Served UEs |
| O-RU 1 | On | UE 1, UE 6, UE a, . . . |
| O-RU 2 | On | UE2, UE 15, UE b, . . . |
| O-RU 3 | On | UE 5, UE 9, UE c, . . . |
| O-RU 4 | On | UE 7, UE 10, UE d, . . . |
| O-RU 5 | On | UE 8, UE 22, UE x, . . . |
| O-RU 6 | Off | — |
| O-RU 7 | On | UE 4, UE 23, UE y, . . . |
| O-RU 8 | On | UE 3, UE 55, UE z, . . . |

In the example of Table 4, O-RUs may correspond to of the O-RUs 641, 642, 643, 644, 645, 646, 647, and 648 exemplified in FIG. 6B, respectively. For example, an O-RU 1 may be the first O-RU 641 configuring the first cell 651, an O-RU 2 may be the second O-RU 642 configuring the second cell 652, an O-RU 3 may be the third O-RU 643 configuring the third cell 653, an O-RU 4 may be the fourth O-RU 644 configuring the fourth cell 654, an O-RU 5 may be the fifth O-RU 645 configuring the fifth cell 655, an O-RU 6 may be the sixth O-RU 646 that is turned off (or deactivated), an O-RU 7 may be the seventh O-RU 647 configuring the seventh cell 657, and an O-RU 8 may be the eighth O-RU 648 configuring the eighth cell 658.

Therefore, among NES state values, ‘on’ may mean a state where the corresponding O-RU is activated or turned on, and ‘off’ may mean a state where the corresponding O-RU is deactivated or turned off. Served UEs may be indicated by UE identifiers, and the O-RU 7 in the off (or deactivated) state exemplifies a case where there is no served UE. As exemplified in Table 4, the topology manager 624 may manage the inactive/active state for each cell and the list of UEs (or UE IDs) served by the corresponding cell.

For example, the serving cell and neighboring cell information for each UE, which is managed by the topology manager 624, may be exemplified as in Table 5 below.

TABLE 5

| | Serving | Neighboring |
|---|---|---|
| UE ID | cell | cell(s) |
| UE 1 | O-RU 1 | O-RU 2, . . . |
| UE 2 | O-RU 2 | O-RU 3, . . . |
| UE 3 | O-RU 8 | O-RU 7, . . . |
| . . . | . . . | . . . |
| UE 8 | O-RU 5 | O-RU 7, . . . |
| UE 9 | O-RU 3 | O-RU 4, . . . |
| UE 10 | O-RU 4 | O-RU 5, . . . |
| . . . | . . . | . . . |

A specific one UE may be served by a specific one cell (or O-RU), and the serving cells exemplified in Table 5 may correspond to cases exemplified based on what was described in FIG. 6B. For example, if the serving cell of the UE 1 is the O-RU 1, the neighboring cells for the UE 1 may include the O-RU 2. If the serving cell of the UE 8 is the O-RU 5, the neighboring cells for the UE 8 may include the O-RU 7.

In addition, as exemplified in Table 5, the topology manager 624 may manage serving cell and neighboring cell information for each UE.

The forms of Table 4 and Table 5 described above are examples to help understanding of the present disclosure, and the topology manager 624 may use an improved scheme that allows it to use a smaller amount of memory than the forms used in Table 4 and/or Table 5.

FIG. 9 is a conceptual diagram of a system for saving network energy by interworking with a non-RT RIC when the NES controller according to the present disclosure is included in a near-RT RIC.

Before referring to FIG. 9, it should be noted that FIG. 9 shows another exemplary embodiment in which the RIC described in FIG. 6A is configured as being separated into a non-RT RIC and a near-RT RIC. In addition, E2 nodes may be configured identically or similarly to those described in FIG. 6B. It should be noted that the E2 nodes and cells (or O-RUs) below the E2 nodes, which are exemplified in FIG. 6B, are omitted in FIG. 9.

Referring to FIG. 9, an NES orchestrator 911, a non-RT RIC 920, and a near-RT RIC 930 may be configured above the E2 nodes.

The NES orchestrator 911 may monitor a current energy consumption (EC) and a QoS level of users of the system, as described in FIG. 4. In addition, the NES orchestrator 911 may determine an energy saving level of the system and set a degree of QSD that may occur due to energy saving by considering monitoring data and a system operation intention of the operator/manager. An NES intent/QSD intent configured in the above-described manner may be transmitted to the non-RT RIC 920.

The non-RT RIC 920 may include a cell abnormality detector 921 and an NES policy generator 922. The cell abnormality detector 921 may perform the same operation as the cell abnormality detector 622 described in FIG. 6. In other words, the cell abnormality detector 922 may detect cell abnormal values using cell-level data and AI/ML models.

The NES policy generator 922 may be a device that performs an operation related to an NES policy among the operations of the NES controller 621 described in FIG. 6A. The NES policy generator 922 may interpret the NES intent and/or QSD intent input from the NES orchestrator 911. The NES policy generator 922 may generate NES policy information by interpreting the NES intent and/or QSD intent. The NES policy information may be converted into a single policy schema or multiple policy schemas. The converted policy schema(s) may be provided to the NES controller 932 included in the near-RT RIC 930 to be described later. In this case, the A1 interface, which is an O-RAN standard interface, may be used when delivering the policy schemas between the NES policy generator 922 and the NES controller 932.

The near-RT RIC 930 may include a topology manager 931, the NES controller 932, and a QoS predictor 933. If the cell abnormality detector 921 is not included in the non-RT RIC 920, the cell abnormality detector 934 may be included in the near-RT RIC 930. It should be noted that the cell abnormality detector 921 is indicated by a dotted line in FIG. 9 to indicate that it may be included selectively.

The topology manager 931 and the QoS predictor 933 may perform the same operations as those described in FIGS. 6A and 6B and those described in FIGS. 7 to 8 with reference to FIGS. 6A and 6B. Therefore, redundant descriptions on the topology manager 931 and the QoS predictor 933 will be omitted.

In the present disclosure, there is provided an example in which the NES controller 621 described in FIG. 6A is configured to be separated into the NES policy generator 922 located in the non-RT RIC 920 and the NES controller 932 located in the near-RT RIC 930. Accordingly, the NES controller 932 illustrated in FIG. 9 may perform the remaining control operations excluding the control operations of the NES policy generator 922. In other words, the NES controller 932 may receive the NES intent and/or QSD intent determined by the NES policy generator 922 from the NES orchestrator 911, and perform the remaining operations excluding the operation of generating NES policy information by interpreting the NES intent and/or QSC intent and the operation of transmitting intent feedback to the NES orchestrator (911).

For example, the NES controller 932 may perform the control operation for allowing all UEs served by deactivation candidate cells (O-RUs) to be handed over to neighboring cells (or O-RUs) as described in FIG. 7. In addition, the NES controller 932 may perform the control operation to activate the deactivation candidate cells (or O-RUs) as described in FIG. 8A and FIG. 8B.

The NES policy information and feedback information on policy enforcement may be exchanged between the NES policy generator 922 located in the non-RT RIC 920 and the NES controller 932 located in the near-RT RIC 930. Such NES policy information and feedback information on policy enforcement may be exchanged using the A1 interface, which is an O-RAN standard interface.

Currently, network energy saving is not stipulated in the standardization organization for 3GPP and/or O-RAN. Therefore, the NES policy is not implemented in the A1 interface either. The present disclosure proposes an NES policy for network energy saving.

An A1 policy delivered from the non-RT RIC 920 to the near-RT RIC 930 through the A1 interface of O-RAN may be composed of a scope part, an objective part, and/or a resource part. The scope part may indicate an identifier of a cell or UE to which the objective part and resource part are applied, and the objective part may describe objective(s) for achieving a goal of the policy. The resource part may include related usage resource information.

A policy using a list of NES cell candidates according to an exemplary embodiment of the present disclosure may be exemplified as shown in Table 6 below.

TABLE 6

```
[
  ″scope″: [
    ″cellIdList″: [
      {″plmnId″: {″mcc″: ″123″,″mnc″: ″45″},
        ″cId″: {″ncI″: 20}},
      {″plmnId″: {″mcc″: ″123″,″mnc″: ″45″},
        ″cId″: {″ncI″: 30}},
      {″plmnId″: {″mcc″: ″123″,″mnc″: ″45″},
        ″cId″: {″ncI″: 40}}
      ]
  } ,
  “nesObjectives″: [
    ″targetNumOffCell″: 2,
    “targetAllowedQosDiff″: 0.8
  },
  ″nesResources″: [
  {
    ″cellIdList″: [
      {″plmnId″: {″mcc″: ″123″,″mnc″: ″45″},
        ″cId″: {″ncI″: 21}},
      {″plmnId″: {″mcc″: ″123″,″mnc″: ″45″},
        ″cId″: {″ncI″: 31}},
    ],
    “preference”: “PREFER”
  },
  }
    ″cellIdList″: [
      {″plmnId″: {″mcc″: ″123″,″mnc″: ″45″},
        ″cId″: {″ncI″: 19}},
      {″plmnId″: {″mcc″: ″123″,″mnc″: ″45″},
        ″cId″: {″ncI″: 29}},
    ],
    “preference”: “AVOID”
  }
}
```

TABLE 7

```
{
  ″scope″: {
    ″cellId″: {
      ″plmnId″: {″mcc″: ″123″,″mnc″: ″45″},
      ″cId″: {″ncI″: 20}
    }
},
  “nesObjectives″: {
    ″targetPNF_EC″: 0,
    “targetAllowedQosDiff″: 0.5
  },
  ″nesResources″: [
  {
    ″cellIdList″: [
      {″plmnId″: {″mcc″: ″123″,″mnc″: ″45″},
        ″cId″: {″ncI″: 21}},
      {″plmnId″: {″mcc″: ″123″,″mnc″: ″45″},
        ″cId″: {″ncI″: 22}},
    ],
    “preference”: “PREFER”
  },
  {
    ″cellIdList″: [
      {″plmnId″: {″mcc″: ″123″,″mnc″: ″45″},
        ″cId″: {″ncI″: 19}},
      {″plmnId″: {″mcc″: ″123″,″mnc″: ″45″},
        ″cId″: {″ncI″: 29}},
    ],
    “preference”: “AVOID”
  }
}
```

Table 6 and Table 7 illustrate two NES policy examples according to the present disclosure.

Table 6 shows an exemplary embodiment of the NES policy, which uses a list of NES candidate cells (or O-RUs) as a scope. The list of NES candidate cells (or O-RUs) obtained from the cell abnormality detector of FIG. 6A, 6B, or 9 described above may be used as the scope. To this end, a list of global cell identifiers each comprising a public land mobile network (PLMN) ID and a cell identifier (cId), which are defined in 3GPP, may be used. In addition, the PLMN ID may be composed of a mobile country code (MCC) and a mobile network code (MNC) ID, which represent a mobile network to which a mobile subscriber subscribes.

For the notation of the objectives (hereinafter, ‘nesObjectives’) of the NES policy, a value of targetNumOffCell indicating the size N_off of the list of NES candidate cells described in the scope part and a value of targetAllowedQosDiff indicating Q_diff used in equation 1 may be used. Table 6 exemplifies another exemplary embodiment of calculating the value of Q_diff by using ‘Q_pred/Q_serv’ instead of ‘Q_serv−Q_pred’ used in FIG. 6. The resources (hereinafter, ‘nesResources’) of the NES policy may indicate preferences for active cells to which UEs served by deactivation candidate cells can be handed over. The preference may be designated as one of ‘SHALL’, ‘PREFER’, ‘AVOID’, and ‘FORBID’ to indicate a usage preference for the corresponding cell list. Table 6 and Table 7 illustrate a case where a list of cells with the preference ‘PREFER’ and a list of cells with the preference ‘AVOID’ are used as nesResources, exemplifying a list of cells to be considered first and a list of cells to be avoided for handover of UEs from cells to be deactivated.

Meanwhile, targetNumOnCell may also be used as nesObjectives to support a case where the NES level is lowered through interpretation of the NES intent and/or QSD intent, that is, the number of deactivated cells is reduced. In this case, the cell lists specified as the scope may include all or some deactivated cells (or O-RUs) that can be reactivated. In this case, nesResources may not be included.

Another exemplary embodiment of the NES policy configuration according to the present disclosure, Table 7, may include single cell identifier information as a scope and targetPNF_EC=0 may be set as nesObjectives. The value of targetPNF_EC may specify an energy consumption of a physical function of the single cell indicated in the scope as zero (0), thereby aiming to deactivate the cell corresponding to the scope. In this case, a deactivation probability of the cell specified in the scope may be increased by lowering a value of targetAllowedQosDiff than in FIG. 7. The usage example of nesResources may be the same as described in Table 6. Therefore, redundant description is omitted.

FIG. 10 is a conceptual diagram of a system for saving network energy by interworking with a near-RT RIC when an NES controller according to the present disclosure is included in a non-RT RIC.

FIG. 10 shows an exemplary embodiment when a near-RT RIC only supports a traffic steering policy. In FIG. 10, as in FIG. 9 described above, E2 nodes may be configured identically or similarly to those described in FIG. 6B. It should be noted that the E2 nodes and cells (or O-RUs) below the E2 nodes, which are illustrated in FIG. 6B, are omitted in FIG. 10.

Referring to FIG. 10, an NES orchestrator 1011, a non-RT RIC 1020, and a near-RT RIC 1030 may be configured above E2 nodes.

The NES orchestrator 1011 may perform the same operations as described in FIG. 4, FIG. 6A, and FIG. 9.

The non-RT RIC 1020 may include a cell abnormality detector 1021, an NES controller 1022, a QoS predictor 1023, and a topology manager 1024. The cell abnormality detector 1021, QoS predictor 1023, and topology manager 1024, which are included in the non-RT RIC 1020, may have the same configuration and perform the operations as described in FIG. 6A to FIG. 9.

In addition, the NES controller 1022 included in the non-RT RIC 1020 may perform the same operations as the NES controller 621 described in FIG. 6A. Compared to FIG. 9, the NES controller 1022 may perform both the operations of the NES policy generator 922 and the NES controller 932.

The near-RT RIC 1030 may include a topology manager 1031. The topology manager 1031 may perform the operations described in FIGS. 6A to 9.

As illustrated in FIG. 10, the near-RT RIC 1021 may support a traffic steering policy instead of supporting the NES policy. As illustrated in FIG. 10, the near-RT RIC 1021 may not perform network energy saving, in other words, may only perform a traffic steering policy of O-RAN. The steering policy may generally specify a single UE identifier or a list of UE identifiers including multiple UE identifiers as a scope. The steering policy may indicate a preference for active cells to which the corresponding UE(s) can be handed over.

As illustrated in FIG. 10, in the case of the near-RT RIC 1030 supporting the traffic steering policy without supporting the NES policy, in order to implement the operations according to the present disclosure, the NES controller 1022 of the non-RT RIC 1020 may generate a traffic steering policy to handover all UEs served by cells to be deactivated to neighboring cells. Then, the NES controller 1022 may transmit the steering policy to a device (not shown in FIG. 10) that enforces traffic steering of the near-RT RIC 1030. Through this, the traffic steering device of the near-RT RIC 1030 may allow the corresponding UEs to be handed over to neighboring cells.

The traffic steering device of the near-RT RIC 1030 may transmit a result of enforcing the traffic steering policy as policy feedback to the NES controller 1022 included in the non-RT RIC 1020.

The NES controller 1022 may identify the policy feedback received from the traffic steering device to determine whether the handover of the UE(s) is completed or failed. Depending on the result of the handover completion or failure, the NES controller 1022 may deactivate the corresponding cell(s) or generate a traffic steering policy for other NES candidate cells. If a new traffic steering policy for other NES candidate cells is generated, the NES controller 1022 may deliver the newly generated steering policy again to the near-RT RIC 1030.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a network energy saving (NES) controller, comprising:
receiving a first network energy saving (NES) intent instructing additional energy saving;
determining a first cell to be deactivated based on the first NES intent;
obtaining a first user equipment (UE) list of all UEs served by the first cell;
determining whether all UEs included in the first UE list are capable of handover;
in response to determining that all UEs included in the first UE list are capable of handover, transmitting a handover instruction command to a first base station managing the first cell, so that all UEs included in the first UE list are handed over to individual target cells; and
in response to receipt of a handover complete message for all UEs included in the first UE list from the first base station, transmitting deactivation instruction information of the first cell to the first base station.

2. The method according to claim 1, further comprising:
receiving a first quality of service (QoS) degradation (QSD) intent;
determining whether a QoS of all UEs included in the first UE list when handed over is within an allowable range of the first QSD intent; and
in response to determining that the QoS of all UEs included in the first UE list when handed over is within the allowable range of the first QSD intent, determining the first cell as a deactivation target.

3. The method according to claim 2, further comprising:
in response to determining that the QoS of all UEs included in the first UE list when handed over is not within the allowable range of the first QSD intent, excluding the first cell from a deactivation target;
determining a second cell to be deactivated that satisfies the allowable range of the first QSD intent;
obtaining a second UE list including all UEs served by the second cell;
determining whether all UEs included in the second UE list are capable of handover;
in response to determining that all UEs included in the second UE list are capable of handover, transmitting a handover instruction command to a second base station managing the second cell, so that all UEs included in the second UE list are handed over to individual target cells; and
in response to receipt of a handover complete message for all UEs included in the second UE list from the second base station, transmitting deactivation instruction information of the second cell to the second base station.

4. The method according to claim 1, further comprising:
in response to a second cell to be further deactivated based on the first NES intent, determining whether all UEs served by the second cell are capable of handover;
in response to determining that all UEs served by the second cell are capable of handover, transmitting a handover instruction command to a second base station managing the second cell, so that all UEs served by the second cell are handed over to individual target cells; and
in response to receipt of a handover complete message for all UEs in the second cell from the second base station, transmitting deactivation instruction information of the second cell to the second base station.

5. The method according to claim 1, further comprising: when transmitting the deactivation instruction information of the first cell, transmitting instruction information instructing an increase in signal transmission power of adjacent cell(s) of the first cell to one or more base stations managing the adjacent cell(s), so that the adjacent cell(s) cover a range of the first cell.

6. The method according to claim 1, wherein the determining of the first cell to be deactivated based on the first NES intent comprises:
calculating a number of candidate cells to be deactivated based on the first NES intent;
providing information on the number of candidate cells to a cell abnormality detector; and
receiving a list of candidate cells to be deactivated from the cell abnormality detector.

7. The method according to claim 1, further comprising:
receiving a second NES intent instructing an increase in network energy;
generating a list of candidate cells to be activated in an order from a cell having a highest load to a cell having a lowest load among cells adjacent to deactivated cells based on the second NES intent; and
transmitting a reactivation command to a second base station managing a fourth cell, so that the fourth cell adjacent to a third cell having the highest load among cells included in the list of candidate cells is reactivated.

8. The method according to claim 7, further comprising:
determining UEs to be handed over to the fourth cell among UEs served by the third cell; and
transmitting handover instruction information to the second base station, so that handover commands are transmitted to the UEs to be handed over to the fourth cell.

9. The method according to claim 1, further comprising:
receiving a first quality of service (QoS) degradation (QSD) intent;
in response to receipt of overloaded cell information for a second cell from a cell abnormality detector, generating a candidate UE list of UEs capable of handover from the second cell to adjacent third cells;
determining a target cell for handover based on the first QSD for each of the UEs included in the candidate UE list, a target cell for a specific UE being one of the third cells; and
transmitting a handover instruction command to second base station(s) managing the third cells, so that a handover command for handover to the determined target cell is transmitted to each of the UEs included in the candidate UE list.

10. A network energy saving (NES) controller comprising at least one processor, wherein the at least one processor causes the NES controller to perform:
receiving a first network energy saving (NES) intent instructing additional energy saving;
determining a first cell to be deactivated based on the first NES intent;
obtaining a first user equipment (UE) list of all UEs served by the first cell;
determining whether all UEs included in the first UE list are capable of handover;
in response to determining that all UEs included in the first UE list are capable of handover, transmitting a handover instruction command to a first base station managing the first cell, so that all UEs included in the first UE list are handed over to individual target cells; and
in response to receipt of a handover complete message for all UEs included in the first UE list from the first base station, transmitting deactivation instruction information of the first cell to the first base station.

11. The NES controller according to claim 10, wherein the at least one processor further causes the NES controller to perform:
receiving a first quality of service (QoS) degradation (QSD) intent;
determining whether a QoS of all UEs included in the first UE list when handed over is within an allowable range of the first QSD intent; and
in response to determining that the QoS of all UEs included in the first UE list when handed over is within the allowable range of the first QSD intent, determining the first cell as a deactivation target.

12. The NES controller according to claim 11, wherein the at least one processor further causes the NES controller to perform:
in response to determining that the QoS of all UEs included in the first UE list when handed over is not within the allowable range of the first QSD intent, excluding the first cell from a deactivation target;
determining a second cell to be deactivated that satisfies the allowable range of the first QSD intent;
obtaining a second UE list including all UEs served by the second cell;
determining whether all UEs included in the second UE list are capable of handover;
in response to determining that all UEs included in the second UE list are capable of handover, transmitting a handover instruction command to a second base station managing the second cell, so that all UEs included in the second UE list are handed over to individual target cells; and
in response to receipt of a handover complete message for all UEs included in the second UE list from the second base station, transmitting deactivation instruction information of the second cell to the second base station.

13. The NES controller according to claim 10, wherein the at least one processor further causes the NES controller to perform:
in response to a second cell to be further deactivated based on the first NES intent, determining whether all UEs served by the second cell are capable of handover;
in response to determining that all UEs served by the second cell are capable of handover, transmitting a handover instruction command to a second base station managing the second cell, so that all UEs served by the second cell are handed over to individual target cells; and
in response to receipt of a handover complete message for all UEs in the second cell from the second base station, transmitting deactivation instruction information of the second cell to the second base station.

14. The NES controller according to claim 10, wherein the at least one processor further causes the NES controller to perform: when transmitting the deactivation instruction information of the first cell, transmitting instruction information instructing an increase in signal transmission power of adjacent cell(s) of the first cell to one or more base stations managing the adjacent cell(s), so that the adjacent cell(s) cover a range of the first cell.

15. The NES controller according to claim 10, wherein in the determining of the first cell to be deactivated based on the first NES intent, the at least one processor further causes the NES controller to perform:
calculating a number of candidate cells to be deactivated based on the first NES intent;
providing information on the number of candidate cells to a cell abnormality detector; and
receiving a list of candidate cells to be deactivated from the cell abnormality detector.

16. The NES controller according to claim 10, wherein the at least one processor further causes the NES controller to perform:
receiving a second NES intent instructing an increase in network energy;
generating a list of candidate cells to be activated in an order from a cell having a highest load to a cell having a lowest load among cells adjacent to deactivated cells based on the second NES intent; and
transmitting a reactivation command to a second base station managing a fourth cell, so that the fourth cell adjacent to a third cell having the highest load among cells included in the list of candidate cells is reactivated.

17. The NES controller according to claim 16, wherein the at least one processor further causes the NES controller to perform:
determining UEs to be handed over to the fourth cell among UEs served by the third cell; and
transmitting handover instruction information to the second base station, so that handover commands are transmitted to the UEs to be handed over to the fourth cell.

18. The NES controller according to claim 10, wherein the at least one processor further causes the NES controller to perform:
receiving a first quality of service (QoS) degradation (QSD) intent;
in response to receipt of overloaded cell information for a second cell from a cell abnormality detector, generating a candidate UE list of UEs capable of handover from the second cell to adjacent third cells;
determining a target cell for handover based on the first QSD for each of the UEs included in the candidate UE list, a target cell for a specific UE being one of the third cells; and
transmitting a handover instruction command to second base station(s) managing the third cells, so that a handover command for handover to the determined target cell is transmitted to each of the UEs included in the candidate UE list.
